(19) United States
(12) Patent Application Publication
(10) Pub. No.: US 2021/0011775 A1
(43) Pub. Date: Jan. 14, 2021

(54) EXECUTION OF CONTAINERIZED PROCESSES WITHIN CONSTRAINTS OF AVAILABLE HOST NODES

(71) Applicant: HEWLETT PACKARD ENTERPRISE DEVELOPMENT LP, Houston, TX (US)

(72) Inventors: Joel Baxter, San Carlos, CA (US); Thomas A. Phelan, San Francisco, CA (US)

(21) Appl. No.: 16/506,935

(22) Filed: Jul. 9, 2019

(51) Int. Cl. G06F 9/50

(52) U.S. Cl. CPC G06F 9/5072; G06F 9/5083; G06F 9/5077

(57) ABSTRACT

The technology disclosed herein enables optimized managing of cluster deployment on a plurality of host nodes. In a particular embodiment, a method includes defining parameters of a cluster for executing a process that will execute in a plurality of containers distributed across one or more of the plurality of host nodes. The method further provides adding a first container portion of the plurality of containers to a first host node portion of the plurality of host nodes. After adding the first container portion, the method includes determining that a remaining host node portion of the plurality of host nodes will not support more of the plurality of containers and adjusting the parameters of the cluster to allow the process to execute on the first host node portion.

### TECHNICAL BACKGROUND

Container orchestration platforms, such as Kubernetes, automate the deployment, scaling, and management of applications that comprise containerized processes. When executing an application that comprises containerized processes, a number of host nodes may be defined for the application. In some cases, the number of host nodes actually available to execute one or more containers of the application may be less than that defined number of host nodes. If the application attempts to expand beyond the available host nodes, then the application may not continue to execute or may not execute effectively until more host nodes become available.

### SUMMARY

The technology disclosed herein enables optimized management of cluster deployment on a plurality of host nodes. In a particular embodiment, a method includes defining parameters of a cluster for executing a process that will execute in a plurality of containers distributed across one or more of the plurality of host nodes. The method further provides adding a first container portion of the plurality of containers to a first host node portion of the plurality of host nodes. After adding the first container portion, the method includes determining that a remaining host node portion of the plurality of host nodes will not support more of the plurality of containers and adjusting the parameters of the cluster to allow the process to execute on the first host node portion.

In some embodiments, after adjusting the parameters of the cluster, the method includes determining that the remaining host node portion will support one or more additional containers of the plurality of containers, adding the one or more additional containers to the remaining host node portion, and adjusting the parameters of the cluster to allow the process to execute with the one or more additional containers. In those embodiments, the method may include adjusting one or more other processes on the plurality of host nodes to make resources available on the remaining host node portion to support the one or more additional containers.

In some embodiments, adjusting the parameters includes redefining a size of the cluster to correspond to the first host node portion. In those embodiments, adjusting the parameters may include reconfiguring container types of the first container portion to perform the process on the first host node portion.

In some embodiments, containers in the first container portion are grouped into one or more pods and adding the first container portion includes adding at least one of the one or more pods to each host node of the first host node portion. In those embodiments, adjusting the parameters of the cluster may include adjusting parameters of at least a portion of the one or more pods.

In some embodiments, defining the parameters of the cluster includes defining a size of the cluster based on an amount of host nodes, wherein the first host node portion includes fewer host nodes than the amount of host nodes.

In some embodiments, one host node of the first host node portion includes a management container for the cluster.

In some embodiments, the plurality of host nodes include a plurality of virtual machines executing on a plurality of host computing systems.

In another embodiment, an apparatus is provided that includes one or more computer readable storage media and a processing system operatively coupled with the one or more computer readable storage media. Program instructions stored on the one or more computer readable storage media that, when read and executed by the processing system, direct the processing system to define parameters of a cluster for executing a process that will execute in a plurality of containers distributed across one or more of the plurality of host nodes. The program instructions further direct the processing system to add a first container portion of the plurality of containers to a first host node portion of the plurality of host nodes. After the first container portion is added, the program instructions direct the processing system to determine that a remaining host node portion of the plurality of host nodes will not support more of the plurality of containers and adjust the parameters of the cluster to allow the process to execute on the first host node portion.

### BRIEF DESCRIPTION OF THE DRAWINGS

FIG. 1 illustrates an implementation for executing containerized processes within constraints of available host nodes.

FIG. 2 illustrates an operational scenario for executing containerized processes within constraints of available host nodes.

FIG. 3 illustrates another operational scenario for executing containerized processes within constraints of available host nodes.

FIG. 4 illustrates yet another operational scenario for executing containerized processes within constraints of available host nodes.

FIG. 5 illustrates a host system architecture for executing containerized processes within constraints of available host nodes.

### DETAILED DESCRIPTION

Executing a process, such as an application, in containers across multiple host nodes allows for flexibility that otherwise might not exist for a computing process. For instance, the process can be scaled depending on how much processing resources are needed/desired for the process. As more resources are needed, additional containers for the process can be established on additional host nodes to provide the resources. If a process needs to add more containers for the process to additional host nodes, those host nodes need to be available to accept and execute the additional containers. When no host nodes, or not enough host nodes, are available to accept all of the additional containers, the cluster control examples herein enable the process to continue executing as efficiently as possible on the host nodes that are available to the process.

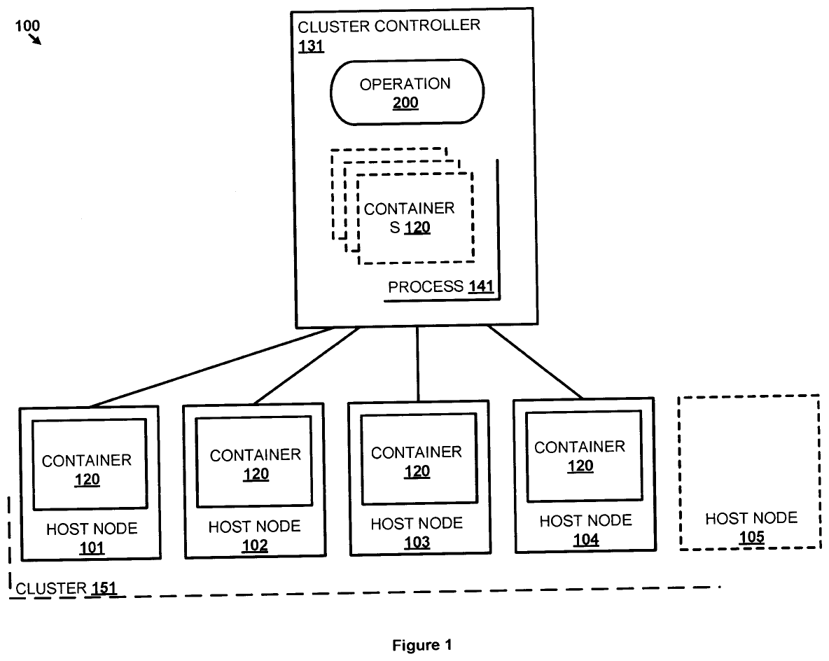

FIG. 1 illustrates implementation 100 for executing containerized processes within constraints of available host nodes. Implementation 100 includes host node 101, host node 102, host node 103, host node 104, and cluster controller 131. Cluster controller 131 and each of host node 101, host node 102, host node 103, and host node 104 communicate over one or more physical and/or logical communication links. The communication links may be direct links or may include intervening networks, systems, and/or devices. Likewise, while not shown, host node 101, host node 102, host node 103, and host node 104 may include communication links to exchange communications there between and/or with other systems not illustrated as part of implementation 100.

In this example, cluster controller 131 manages the execution of process 141 on a cluster of host nodes. In some examples, cluster controller 131 may be executing on a host node rather than being implemented as a distinct computing system. The host node for cluster controller 131 may be considered part of cluster 151. Process 141 executes in one or more instances of single container 120, with each instance of container 120 executing on a respective host node. Cluster 151 therefore includes the instances of container 120 and, optionally, cluster controller 131. In other examples, a process may execute in a more complex manner with instances of more than one container and each host node may execute more than one container thereon. For example, a process may comprise a multi-tier application wherein each tier of the application comprises one or more containers. Each of host node 101, host node 102, host node 103, and host node 104 may comprise a physical computing system (e.g., a server) or may comprise a virtual machine executing on a physical computing system—including combinations thereof.

Cluster controller 131 determines how many host nodes are required for instances of container 120 in order for process 141 to execute as configured in the parameters for cluster 151 and controls the host nodes to execute those instances. Cluster controller 131 performs operation 200 to instantiate instances of container 120 on host node 101, host node 102, host node 103, and host node 104 and to adjust the configuration of cluster 151 to operate within the existing limitations.

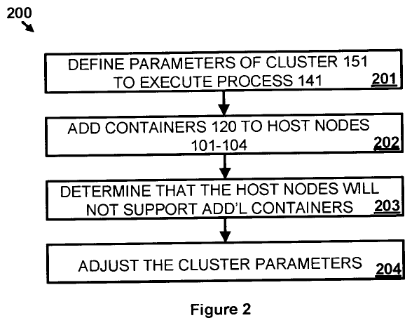

FIG. 2 illustrates operation 200 for executing containerized processes within constraints of available host nodes. Operation 200 includes cluster controller 131 defining parameters of cluster 151 for executing process 141 that will execute in one or more containers 120 distributed across one or more host nodes, such as host node 101, host node 102, host node 103, and host node 104 (201). Cluster controller 131 may define the parameters of cluster 151 by receiving the parameters of cluster 151 from a user, by receiving the parameters from another system along with, or included in, instructions to execute process 141 (e.g., receiving the parameters from a user workstation), by using a predetermined default set of parameters (e.g., parameters programmed into cluster controller 131 for processes controlled thereby, which may differ depending on the particular process or type of process), or may be defined in some other manner. The parameters may define a number of containers 120 that will perform process 141, the number of containers may be a maximum, minimum, range, or precise number (i.e., no more, no fewer), may define a number of host nodes on which process 141 will execute, the number of host nodes may also be a minimum, maximum or precise number, may define an amount of host node resources used for process 141 (e.g., CPU time, amount of memory used, network bandwidth, etc.), the amount of host node resources may be defined on a per container basis, on the basis of a group of containers (e.g., the pods discussed below), or may be defined for process 141 as a whole and may be a minimum, maximum, range, or precise amount of resources, or may define the size of cluster 151 in some other manner—including combinations thereof.

In an example, process 141 may be configured to execute in as many containers as necessary to handle the current demand for process 141 (i.e., the parameters indicate that an unlimited number of containers and/or host nodes should be used). In other cases, there may be a defined upper limit to the number of host nodes available to process 141 since computing resources are not infinite. In other cases, process 141 may be defined based on a desired number of host nodes and/or containers to be used for process 141. For example, a user may determine goals for a particular processing job for which process 141 will be used. Those goals may be that the processing job should be completed in a particular amount of time or for a particular cost (since computing resources many times have a monetary cost associated with their use). The desired number of containers and/or host nodes to be used by process 141 would, therefore, be set by the user to correspond to those goals. In some cases, the user may be able to provide cluster controller 131 with the goals as configuration parameters and cluster controller 131 converts those goals to size parameters for cluster 151 to achieve those goals.

Cluster controller 131 adds a first portion of containers 120 to a first portion host nodes (202). In this example, the first portion of host nodes comprises host node 101, host node 102, host node 103, and host node 104, which each host a single instance of container 120. In other examples, each host node may be able to handle more than one instance of container 120. Likewise, while not shown, each host node may be running containers, or other types of processes, in addition to container 120, which would not be considered part of cluster 151 for process 141. To add an instance of container 120, cluster controller 131 may transfer software representing container 120 to each host node. The software may be stored directly on cluster controller 131 or may be stored elsewhere, such as in a network attached storage repository. In the latter example, cluster controller 131 may instruct that the software for container 120 be transferred directly from the storage system to the respective host node. The instances of container 120 may be added to the respective host systems at substantially the same time or may be added sequentially. In some cases, cluster controller 131 may add instances of container 120 based on demand for process 141. For example, cluster controller 131 may start by adding container 120 to host node 101, monitor demand for process 141, and then add an instance of container 120 to host node 102 to help meet that demand. As the demand increases further, cluster controller 131 adds an instance of container 120 to host node 103 and then another instance of container 120 to host node 104.

In this example, the operating parameters determined for cluster 151 allow for process 141 to expand beyond the four containers 120 on the four respective host nodes 101-104. Thus, after adding the first portion of containers 120, cluster controller 131 determines that a remaining portion of host nodes will not support more of containers 120 (203). For example, cluster controller 131 may determine that the operating parameters for cluster 151 allow cluster 151 to expand at least to another host node 105. However, host node 105 either does not physically exist (e.g., there is no other host node accessible by cluster controller 131) or the available resources of host node 105 are not enough to support an instance of container 120. Cluster controller 131 may track the status of host nodes in connection with cluster controller 131 (e.g., may receive information from each host node notifying cluster controller 131 of the host node's status, such as the state of the host node's resources) or may rely on another system that obtains and manages the host node status information. Regardless of the reason for host node 105 (and any additional host nodes beyond host node 105) being unavailable, cluster controller 131 cannot expand cluster 151 beyond host node 101, host node 102, host node 103, and host node 104 when it determines that host node 105 is unavailable.

After determining that host node 105 is not available, cluster controller 131 adjusts the parameters of cluster 151 to allow process 141 to execute on host node 101, host node 102, host node 103, and host node 104 (204). In some cases, process 141 may not run at all until cluster 151 can be expanded beyond host node 101, host node 102, host node 103, and host node 104. Therefore, cluster controller 131 adjusts the operating parameters of process 141 to redefine the size of cluster 151 to the instances of container 120 operating on host node 101, host node 102, host node 103, and host node 104. After such an adjustment, process 141 will at least run even though process 141 is running on a smaller cluster than originally desired. In some examples, even if process 141 will run on a smaller cluster size, the operating parameters may be adjusted to make process 141 run more effectively on the current size of cluster 151. For instance, the operating parameters may originally define a lesser amount of host node processing/memory resources for use by each instance of container 120, which would be accounted for by more instances of container 120 being added. However, since host node 105 is not available in this example, the operating parameters may be adjusted to allow each instance of container 120 to use more of the resources of the respective host nodes (should those resources be available).

While process 141 is implemented using only one container, other processes may be implemented using multiple types of containers. For example, a container of one type may perform one aspect of process 141 while another container of another type may perform a different aspect of process 141 (e.g., in the examples below, containers of different types are organized into pods to perform different tiers of application 301). In such examples, cluster controller 131 may determine that a different arrangement of container types would more effectively implement a process using multiple types of containers. Cluster controller 131 may therefore remove one or more instances of one type of a container on the available portion of host nodes and replace those instances with one or more instances of another type of container to make more effective use of the available host nodes' resources.

Cluster controller 131 may continue to monitor the availability of additional host nodes and, should additional host nodes become available, cluster controller 131 may redefine the operating parameters of process 141 again to increase the size of cluster 151. For example, host node 105 may become available and the operating parameters of process 141 may then be adjusted to increase the size of cluster 151 to five host nodes. Cluster controller 131 would then add an instance of container 120 to host node 105 in accordance with those newly adjusted operating parameters. Cluster controller 131 may then continue to redefine the operating parameters of process 141 as more host node resources become available (at least until the originally defined size for cluster 151 is reached). As such, cluster controller 131 is able to continually ensure process 141 is operating most effectively even though the size of cluster 151 is less than what was originally provided by the operating parameters for process 141.

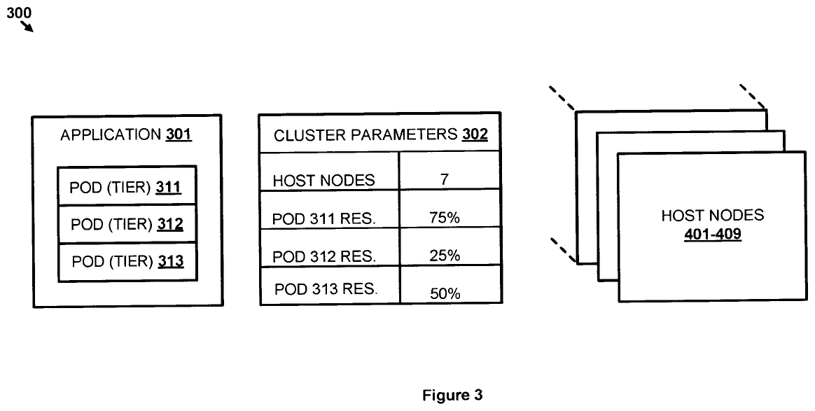

FIG. 3 illustrates operational scenario 300 for executing containerized processes within constraints of available host nodes. Operational scenario 300 includes application 301, which is an example of process 141 from the above examples, cluster parameters 302, which are an example of the operating parameters for process 141 on cluster 151, and host nodes 401-409, which are the host nodes that are potentially available for application 301 to run on. In this example, the containers that comprise an instance of application 301 are arranged into pod 311, pod 312, and pod 313. Pods are used by some container orchestration platforms to group containers that must be run on the same host nodes. Thus, pod 311, pod 312, and pod 313 each include one or more containers that must execute on the same host node. Application 301 is a multi-tiered application in this example as well. Each of pods 311-313 implement a respective tier of application 301, which means application 301 is a three-tier application. Other examples of multi-tiered applications may include a different number of tiers. Likewise, other examples may implement one or more of the tiers in multiple pods or a single pod may implement at least a portion of more than one tier.

In this example, cluster parameters 302 indicates that application 301 should execute on seven host nodes and indicates an amount of resources of each host node that should be used for each of pods 311-313. The amount of resources is defined as a percentage, which presumes each host node has an identical amount of resources to allocate, and is defined based on the resources as a whole rather than distinct categories of resources (e.g., processing resources, memory resources, etc.). Other examples may, therefore, define the resources that should be allocated to each pod more particularly than cluster parameters 302 defines in this example. Based on the resource percentages defined by cluster parameters 302, pod 311 can share a host node with pod 312 but not pod 313 because sharing with pod 313 would put the amount of resources used on the host node over 100%. Likewise, pod 313 can share a host node with one or two instances of pod 312 or can share a host node with another instance of pod 313 (i.e., pod 313 for another instance of application 301). Pod 312 can also share a host node with up to 3 other instances of pod 312 (i.e., instances of pod 312 for other instances of application 301). In this example, if the resources of any of host nodes 401-409 are not used by an instance of pod 311, pod 312, and pod 313, those resources may be used by other processes (i.e., host nodes 401-409 are not used solely to implement instances of application 301.

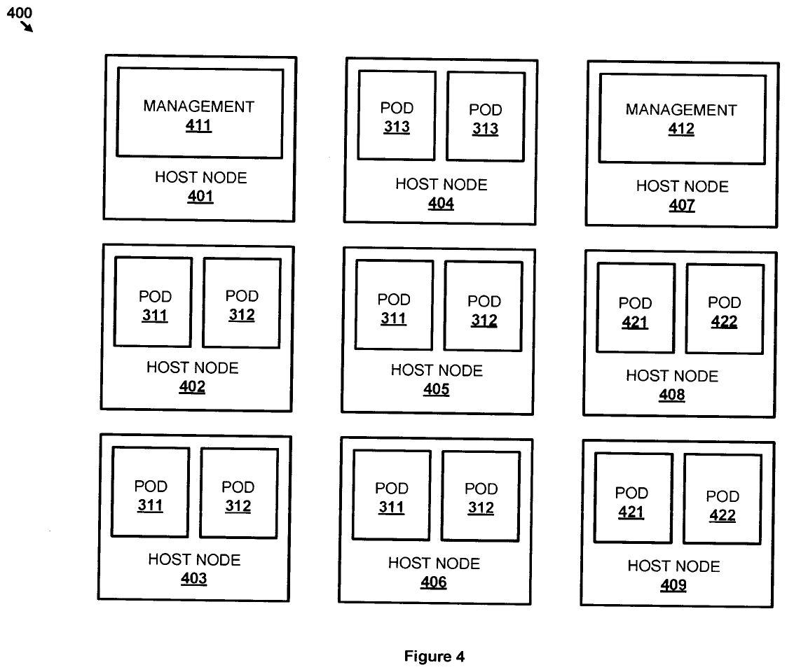

FIG. 4 illustrates operational scenario 400 for executing containerized processes within constraints of available host nodes. Operational scenario 400 is an example of application 301 being implemented on host nodes 401-409 in accordance with cluster parameters 302. While not shown, host nodes 401-409 may communicate over one or more communication networks (e.g., local area network(s)). Host nodes 401-409 host application 301 and another application. In this example, application 301 is managed by management container 411 on host node 401, which manages the implementation of pod 311, pod 312, and pod 313, and uses one of the seven host nodes indicated by cluster parameters 302. Other examples may not count the host node used by management container 411 in the seven host nodes. Management container 411 is alone on host node 401 in this case but may share a host node with one or more pods in other examples. Management container 411 is an example implementation for cluster controller 131.

In operational scenario 400, application 301 is implemented by management container 411 as one or more groups of one pod 311, one pod 312, and one pod 313. Thus, when expanding application 301 in the cluster of host nodes 401-409, resources in host nodes 401-409 are needed for one instance of each pod 311, pod 312, and pod 313 (i.e., the ability to add only one or two of the pods would not expand application 301, which requires all three). In other examples, an application may be able to expand on an individual pod basis. For example, an application may be able to expand only a particular tier by adding one or more pods that implement that tier.

Based on cluster parameters 302, management container 411 performs operation 200 to add an instance of pod 311 and pod 312 to host node 402, add an instance of pod 311 and pod 312 to host node 403, and adds two instances of pod 313 to host node 404. Host nodes 402-404 therefore include two groups of pod 311, pod 312, and pod 313 for application 301. For example, pod 311 and pod 312 on host node 402 may be associated with one pod 313 on host node 404 and pod 311 and pod 312 on host node 403 may be associated with the other pod 313 on host node 404. Management container 411 may use an algorithm that best fits pods 311-313 onto host nodes based on the resources needed for each pod, as defined in cluster parameters 302. For example, the algorithm in this example determined that pod 311 and pod 312 can share a host node in order to use 100% of the host node's resources and made a similar determination regarding the two instances of pod 313 on host node 404.

Management container 411 then tries to expand to two more groups of pod 311, pod 312, and pod 313 for application 301, which would result in satisfying cluster parameters 302 with four groups across seven host nodes, including host node 401 for management container 411. Once management container 411 has added instances of pod 311 and pod 312 to respective host nodes 405 and 406, management container 411 determines that no host node resources are available to continue expanding the cluster for application 301 in accordance with operation 200. In this example, another application is running on host nodes 407-409. That other application has its own management container 412 on host node 407 and each of host nodes 408 host an instance of pod 421 and pod 422. When running pod 421 and pod 422 neither host node 408 nor host node 409 have enough remaining resources to support an instance of pod 313. Therefore, in accordance with operation 200, management container 411 adjusts cluster parameters 302 to better implement application 301 on the six available host nodes rather than the initially defined seven. Seven host nodes would have allowed for another host node to support two instances of pod 313 and, therefore, double the number of pod groups running for application 301 from two to four.

In this case, management container 411 may simply reduce the number of host nodes available for application 301 to six within cluster parameters 302, which may trigger an algorithm that best fits pods of application 301 into six host nodes instead of the previously defined seven. For example, management container 411 may remove pod 311 from host node 406 and add an instance of pod 313 in its place due to the removal of pod 311 freeing up 75% of the resources of host node 406. That newly added instance of pod 311, when associated with pod 311 and pod 312 on host node 405, creates a third group of pods for application 301. While three groups of pods for application 301 is less than the desired four, which was allowed for with the originally specified seven host nodes, the three groups are better than the two groups that were running previously. In some cases, management container 411 may also reserve the remaining resources on host node 406 (which would be 25% of the resources if pod 312 is allowed to remain, though unused, on host node 406) so that those resources can be used once a seventh host node becomes available.

In another example, application 301 may be prioritized over the application managed by management container 412. In that case, management container 411 may notify management container 412 that another host node is required for application 301. Management container 412 may then remove pod 421 and pod 422 from either host node 408 or host node 409. Once host node 408 or host node 409 becomes available, management container 411 will expand the cluster of application 301 to that host node. In some of these cases, management container 411 may still lower the number of host nodes for application 301 to six while management container 411 waits for management container 412 to make host node 408 or host node 409 available. Once host node 408 or host node 409 is available, management container 411 would simply update the number of host nodes to seven and expand to the seventh node.

In yet another example, management container 411 may change the resource requirements of at least a portion of the pods to implement more pod groups for application 301. For example, as noted previously, if all seven host nodes were available, four pod groups could have been implemented by management container 411. Management container 411 may alter the resources required for pod 311, pod 312, and pod 313 (or the individual containers therein) so that all three pods can run on each host node 405 and host node 406 while still allowing the resource requirements for instances of pod 311, pod 312, and pod 313 to remain as originally defined by cluster parameters 302. The resource adjustments would, therefore, allow four groups of pods to run for application 301 on the six available host nodes, albeit two of those pod groups would be running at potentially reduced capacity.

It should be understood that strategies for optimizing the distribution of pods on fewer than a desired amount of host nodes other than those detailed above may also be used when adjusting cluster parameters 302.

While the examples above have management container 411 perform all the steps of operation 200, other examples may not allow for management container 411 to be modified to perform operation 200. In those examples, another container running on host node 401, on another host node (if available), or another system in communication with management container 411 may perform operation 200 as a proxy to management container 411. For example, the proxy may receive the initial cluster parameters 302 and pass cluster parameters 302 to management container 411. When the proxy is informed, either by management container 411 or some other source, that the cluster for application 301 was unable to be expanded to a seventh node, the proxy may adjust cluster parameters 302 to define a six node cluster and pass the adjusted cluster parameters 302 to management container 411 as an update to the previous version of cluster parameters 302. Management container 411 may then adjust the distribution of instances of pod 311, pod 312, and pod 313 for application 301 in a manner similar to that described above. In other examples, the proxy may adjust more than the size of the cluster (e.g., may adjust the resource requirements) as addressed in other examples above. The proxy therefore allows for the cluster usage optimization that operation 200 provides without having to modify management container 411.

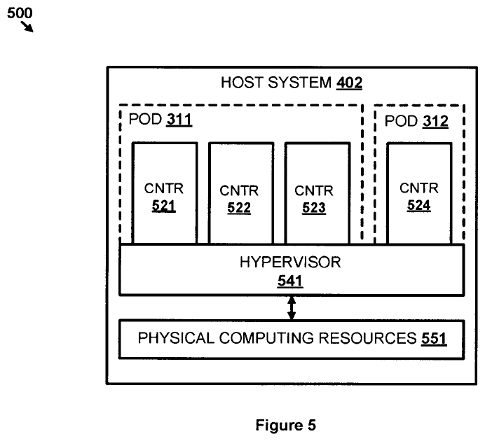

FIG. 5 illustrates computing architecture 500 for executing containerized processes within constraints of available host nodes. Computing architecture 500 is shown as an example of host node 402 but may be an example of any of host nodes 401-409 with different pods or containers running thereon or host nodes 101-104 with container 120 running thereon, although any of those elements may use different architectures. As noted above, a host node may be a physical computing system or may be a virtualized computing system executing on a physical computing system. Computing architecture 500 is an example of a physical computing system, although computing architecture 500 could be virtualized on an underlying physical computing system.

In this example, host computing system 402 executes hypervisor 541 to allocate physical computing resources 551 among pod 311 and pod 312. Physical computing resources 551 may include processing resources (e.g., CPU time/cores), memory space (e.g., space in host node 402's random access memory), network interfaces (e.g., Ethernet, WiFi, etc.), user interfaces, or any other type of resource that a physical computing system may include. In this example, pod 311 includes container 521, container 522, and container 523 while pod 312 includes container 524. Since instances of containers within a pod are required to run on the same host node, container 521, container 522, and container 523 are all running on host node 402. Even though pod 312 includes only a single container 524, container 524 is organized into a pod for consistency with the other pods of application 301. In other examples, container 524 may be treated independently of a pod. Similarly, while shown as pod 311, pod 311 may just be used by management container 411 as an indicator that container 521, container 522, and container 523 need to run on the same host node. Thus, when run on host node 402, host node 402 may not be informed that the individual containers form pod 311. Of course, different container orchestration platforms may direct host nodes to handle pods/containers in different manners.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method for managing cluster deployment on a plurality of host nodes, the method comprising:
defining parameters of a cluster for executing a process that will execute in a plurality of containers distributed across one or more of the plurality of host nodes;
adding a first container portion of the plurality of containers to a first host node portion of the plurality of host nodes;
after adding the first container portion, determining that a remaining host node portion of the plurality of host nodes will not support more of the plurality of containers; and
adjusting the parameters of the cluster to allow the process to execute on the first host node portion.

2. The method of claim 1, further comprising:
after adjusting the parameters of the cluster:
determining that the remaining host node portion will support one or more additional containers of the plurality of containers;
adding the one or more additional containers to the remaining host node portion; and
adjusting the parameters of the cluster to allow the process to execute with the one or more additional containers.

3. The method of claim 2, further comprising:
adjusting one or more other processes on the plurality of host nodes to make resources available on the remaining host node portion to support the one or more additional containers.

4. The method of claim 1, wherein adjusting the parameters comprises:
redefining a size of the cluster to correspond to the first host node portion.

5. The method of claim 4, wherein adjusting the parameters further comprises:
reconfiguring container types of the first container portion to perform the process on the first host node portion.

6. The method of claim 1, wherein containers in the first container portion are grouped into one or more pods and wherein adding the first container portion comprises:
adding at least one of the one or more pods to each host node of the first host node portion.

7. The method of claim 6, wherein adjusting the parameters of the cluster comprises:
adjusting parameters of at least a portion of the one or more pods.

8. The method of claim 1, wherein defining the parameters of the cluster comprises:
defining a size of the cluster based on an amount of host nodes, wherein the first host node portion includes fewer host nodes than the amount of host nodes.

9. The method of claim 1, wherein one host node of the first host node portion comprises a management node for the cluster.

10. The method of claim 1, wherein the plurality of host nodes comprise a plurality of virtual machines executing on a plurality of host computing systems.

11. An apparatus for managing cluster deployment on a plurality of host nodes, the apparatus comprising:
one or more computer readable storage media;
a processing system operatively coupled with the one or more computer readable storage media; and
program instructions stored on the one or more computer readable storage media that, when read and executed by the processing system, direct the processing system to:
define parameters of a cluster for executing a process that will execute in a plurality of containers distributed across one or more of the plurality of host nodes;
add a first container portion of the plurality of containers to a first host node portion of the plurality of host nodes;
after the first container portion is added, determine that a remaining host node portion of the plurality of host nodes will not support more of the plurality of containers; and
adjust the parameters of the cluster to allow the process to execute on the first host node portion.

12. The apparatus of claim 11, wherein the program instructions further direct the processing system to:
after the parameters of the cluster are adjusted:
determine that the remaining host node portion will support one or more additional containers of the plurality of containers;
add the one or more additional containers to the remaining host node portion; and
adjust the parameters of the cluster to allow the process to execute with the one or more additional containers.

13. The apparatus of claim 12, wherein the program instructions further direct the processing system to:
adjust one or more other processes on the plurality of host nodes to make resources available on the remaining host node portion to support the one or more additional containers.

14. The apparatus of claim 11, wherein to adjust the parameters, the program instructions direct the processing system to:
redefine a size of the cluster to correspond to the first host node portion.

15. The apparatus of claim 14, wherein to adjust the parameters, the program instructions further direct the processing system to:
reconfigure container types of the first container portion to perform the process on the first host node portion.

16. The apparatus of claim 11, wherein containers in the first container portion are grouped into one or more pods and wherein to add the first container portion, the program instructions direct the processing system to:
add at least one of the one or more pods to each host node of the first host node portion.

17. The apparatus of claim 16, wherein to adjust the parameters of the cluster, the program instructions direct the processing system to:
adjust parameters of at least a portion of the one or more pods.

18. The apparatus of claim 11, wherein defining the parameters of the cluster comprises:
defining a size of the cluster based on an amount of host nodes, wherein the first host node portion includes fewer host nodes than the amount of host nodes.

19. One or more computer readable storage media having program instructions stored thereon for managing cluster deployment on a plurality of host nodes, the program instructions, when executed by a processing system, direct the processing system to:
define parameters of a cluster for executing a process that will execute in a plurality of containers distributed across one or more of the plurality of host nodes;
add a first container portion of the plurality of containers to a first host node portion of the plurality of host nodes;
after the first container portion is added, determine that a remaining host node portion of the plurality of host nodes will not support more of the plurality of containers; and
adjust the parameters of the cluster to allow the process to execute on the first host node portion.

20. The apparatus of claim 19, wherein the program instructions further direct the processing system to:
after the parameters of the cluster are adjusted:
determine that the remaining host node portion will support one or more additional containers of the plurality of containers;
add the one or more additional containers to the remaining host node portion; and
adjust the parameters of the cluster to allow the process to execute with the one or more additional containers.
